(19) United States
(12) Patent Application Publication
(10) Pub. No.: US 2024/0239017 A1
(43) Pub. Date: Jul. 18, 2024

(54) FEEDSTOCK HOMOGENIZER WITH INTEGRATED SEPARATOR

(71) Applicant: AMPACET CORPORATION, Tarrytown, NY (US)

(72) Inventor: Eli MARGALIT, Moshav yaad (IL)

(73) Assignee: AMPACET CORPORATION, Tarrytown, NY (US)

(21) Appl. No.: 18/560,071

(22) PCT Filed: May 2, 2022
(86) PCT No.: PCT/US2022/027289

§ 371 Date: Nov. 9, 2023

Related U.S. Application Data
(60) Provisional application No. 63/187,770, filed on May 12, 2021.

(51) Int. Cl. B29B 7/00; B01F 23/70; B01F 27/61; B01F 35/21; B01F 35/22; B01F 35/71; B01F 35/75; B29B 7/08; B29B 7/10; B29B 7/14; B29B 7/26; B29B 7/28; B29B 7/84

(52) U.S. Cl. CPC B29B 7/005; B01F 23/708; B01F 27/61; B01F 35/21112; B01F 35/2112; B01F 35/2117; B01F 35/2209; B01F 35/718; B01F 35/75415; B01F 35/7547; B29B 7/08; B29B 7/106; B29B 7/14; B29B 7/26; B29B 7/28; B29B 7/84

(57) ABSTRACT

A homogenizer for homogenously blending a feedstock includes a separator, an agitator and a hopper integrated as a single unit in a common housing. The separator receives a material feed, in the form of a fluid medium carrying a composite feedstock, and separates the composite feedstock from the fluid medium. The agitator receives the separated composite feedstock from the separator, and mixes the composite feedstock to yield the homogenously blended feedstock. The hopper receives the homogenously blended feedstock from the agitator and holds the homogenously blended feedstock for release to either a processing machine or a storage container. The homogenizer is controlled by one or more control units that use signals received from a sensor in the hopper to control the delivery of a material feed to the homogenizer, and the flow of feedstock therethrough.

### FIELD OF THE INVENTION

The present invention relates to an apparatus and method for mixing a composite feedstock to yield a homogenously blended feedstock. In particular, the present invention is inclusive of an homogenizer with an integrated separator and methods of using the same.

### BACKGROUND OF THE INVENTION

In plastics manufacturing, a variety of industrial processes (e.g., injection molding, blow molding, extrusion, 3-D printing, etc.) are used to create plastic products. In each of these processes, a processing machine receives a feedstock that is manipulated to create the end product. Generally, the feedstock is a composite of several raw materials (e.g., polymers, colorants, and other additives). Importantly, to better ensure uniform and consistent characteristics in the end product, the feedstock should be a homogenous blend of the several raw materials.

In some practices the feedstock is produced on site where the plastic product is to be made. In such instances, large systems may be employed for sourcing each of the raw materials, combining the raw materials in a common receiving unit to generate a composite feedstock, directing the composite feedstock to a homogenizer for mixing into a homogenous blend, and then releasing the homogenously blended feedstock into a processing machine.

In other practices, the feedstock may be produced at a first site and then shipped to a second site where the plastic product will be produced. In these instances, a quantity of the composite feedstock is weighed at the first site to prepare an accurate batch volume of the feedstock, and then shipped to the second site for use in a manufacturing process. The weighed batch of feedstock may optionally be mixed at the first site to create a homogenous blend, prior to shipping, or may be packaged without mixing at the first site. However, even if mixing is performed at the first site, a second mixing is commonly performed at the second site in order to ensure a homogenous blend of the feedstock, and remedy any settling or separation of the raw materials that may have occurred during shipment.

The systems used to create feedstocks for processing machines are large and complex. Even in practices where a feedstock is created at a first site and shipped to a second site, there remains substantial system requirements at the second site. Typically, a system at a second site will include an extraction unit for extracting and transferring a feedstock from a shipping package; a receiving unit for separating the feedstock from a transfer medium; and a mixing unit for mixing the feedstock into a homogenous blend. Each of these units requires individual cleaning and maintenance, and each unit will requires flow control devices for controlling a flow of a material feed or feedstock into and out of that unit.

Thus, despite the advances provided to date in the art, there remains a need for improvements to simplify systems for handling feed materials in industrial processes, including though not limited to plastics manufacturing processes.

### SUMMARY OF THE INVENTION

An homogenizer for homogenously blending a feedstock comprises a separator configured to receive a material feed in the form of a fluid medium carrying a composite feedstock, and to separate the composite feedstock from the fluid medium; an agitator configured to receive the separated composite feedstock from the separator, and to mix the composite feedstock to yield the homogenously blended feedstock; and a hopper configured to receive a homogenously blended feedstock from the agitator, and to hold the homogenously blended feedstock for release to either a processing machine or a storage container. The separator, agitator, and hopper are integrated within a common housing.

The separator comprises a reception chamber having a vacuum outlet and a feed inlet, the vacuum outlet being configured to communicate with a vacuum device for generation of a negative vacuum pressure within the reception chamber, and the feed inlet being configured to communicate with a feed supply for delivery of a material feed into the reception chamber under force of a negative pressure generated through the vacuum outlet. A separation mechanism is provided within the reception chamber, positioned within a fluid flow path between the feed inlet and the vacuum outlet, and is configured to separate a material feed received through the feed inlet into substantially separate components of a fluid medium and a composite feedstock.

In some examples, the separator mechanism is a filter having a mesh size sufficient to permit passage of a fluid medium therethrough while blocking passage of a composite feedstock therethrough. In such examples, a blowback device may also be provided and configured to generate a blowback fluid flow through the filter for ejecting particles that have attached to the filter during separation of a composite feedstock from a fluid medium. In other examples, the separator mechanism is a deflector baffle sized and dimensioned to obstruct and deflect a flow of material feed through the reception chamber, such that there is induced a turbulent flow in the material feed that separates the composite feedstock from the fluid medium.

An unobstructed opening is provided in a bottom region of the reception chamber for passage of composite feedstock from the separator to the agitator, and the separation mechanism is positioned in an upper region of the reception chamber such that composite feedstock separated from a fluid medium in a material feed falls by gravity to the bottom region of the separator, through the unobstructed opening, and into the agitator.

The agitator comprises a mixing chamber having a mixing mechanism for mixing a composite feedstock to yield a homogenously blended feedstock, the mixing mechanism comprising at least one of: a stirrer; a screw; an auger; a shaker; and a rotating drum. In some examples, a lower wall of the mixing chamber is oriented at an angle relative to ground with a release gate provided at a lower region of the mixing chamber such that feedstock within the mixing chamber is urged toward the release gate under force of gravity. In such examples, the lower wall of the mixing chamber may be oriented at an angle between about 15° to about 45°. In other examples, the lower wall may be oriented at an angle between about 20° and about 0°. An ejection device may be provided and configured to urge feedstock through the release gate.

The hopper comprises a storage chamber and a batch sensor within the storage chamber, the batch sensor being configured to generate signals informing on the presence of a predetermined quantity of feedstock within the storage chamber. The batch sensor may include at least one of a volumetric sensor; a height sensor; and a weight sensor. A control unit receives signals from the batch sensor for use in controlling a material feed to the homogenizer and for controlling flow gates within the homogenizer.

In operation, the homogenizer receives a material feed comprising a fluid medium and a composite feedstock in the separator, through a feed inlet that communicates with a reception chamber within the separator; separates the composite feedstock from the fluid medium, withdrawing the fluid medium from reception chamber, and passing the composite feedstock to the agitator; mixes the composite feedstock in a mixing chamber of the agitator to yield a homogenously blended feedstock; and releases the homogenously blended feedstock from the agitator to the hopper.

Operation of the homogenizer is controlled by one or more control units. The control unit periodically operates a vacuum device for a predetermined period of time to generate a negative pressure in the reception chamber for drawing a predetermined quantity of material feed into the reception chamber through the feed inlet. The control unit then operates a mixing mechanism in the agitator for a period of time that is predetermined to sufficiently mix a composite feedstock to yield a homogenously blended feedstock. Thereafter, the control unit triggers an actuator to open a release gate in the mixing chamber for releasing the homogenously blended feedstock from the mixing chamber to the hopper, and receives signals from a batch sensor in a storage chamber of the hopper to determine when a predetermined quantity of feedstock has been received within the storage chamber (e.g., corresponding with the fill batch quantity mixed in the agitator). The control unit is configured to periodically operate the vacuum device to deliver predetermined quantities of material feed into the reception chamber of the separator based on determinations made from the signals received from the batch sensor.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIG. 1 shows a front elevation view of a homogenizer according to the present invention;

FIG. 2 shows a right side elevation view of the homogenizer in FIG. 1;

FIG. 3 shows a cross-section view of the homogenizer in FIG. 2, as viewed along line A-A;

FIG. 4 shows a front elevation view of a homogenizer according to the present invention;

FIG. 5 shows a right side elevation view of the homogenizer in FIG. 4; and

FIG. 6 shows a cross-section view of the homogenizer in FIG. 5, as viewed along line A-A.

### DETAILED DESCRIPTION OF THE INVENTION

The following disclosure discusses the present invention with reference to the examples shown in the accompanying drawings, though does not limit the invention to those examples.

The use of any and all examples, or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

The word “substantially”, as used herein with respect to any property or circumstance, refers to a degree of deviation that is sufficiently small so as to not appreciably detract from the identified property or circumstance. The exact degree of deviation allowable in a given circumstance will depend on the specific context, as would be understood by one having ordinary skill in the art.

Use of the terms “about” or “approximately” are intended to describe values above and/or below a stated value or range, as would be understood by one having ordinary skill in the art in the respective context. In some instances, this may encompass values in a range of approx. +/−10%; in other instances there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

Herein the term “composite feedstock” refers to a collection of raw materials, which may include though does not require, and is not limited to: polymers; pigments; color-additives (e.g., ultraviolet light inhibitors); property additives (e.g., reinforcing fibers, fillers, coupling agents, etc.); plasticizers; stabilizers; processing aids; etc.

Herein, the term “mixing mechanism” refers to mechanisms for mixing a feedstock to produce a homogenous blend of the raw materials therein, and may include, though is not limited to: a stirrer; a screw; an auger; a shaker; a rotating drum; and the like.

Herein, the term “actuator” refers to mechanisms for moving or otherwise controlling a movable structure (e.g., opening a passageway, or moving a gate to open a passageway), and may include, though is not limited to: a hydraulic piston; a pneumatic valve; and the like.

Herein, the term “processing machine” refers to any machine for producing a manufactured part from a material feed, and may include, though is not limited to: injection molding machines; blow molding machines; extrusion machines; 3-D printing machines; and the like.

Recitations of a value range herein, unless indicated otherwise, serves as a shorthand for referring individually to each separate value falling within the stated range, including the endpoints of the range, each separate value within the range, and all intermediate ranges subsumed by the overall range, with each incorporated into the specification as if individually recited herein.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

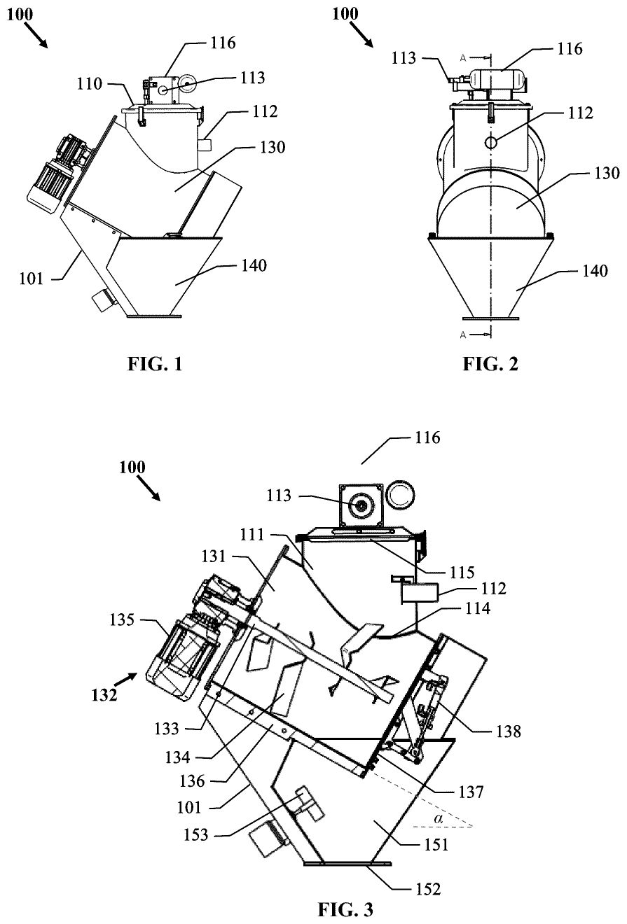

FIGS. 1-3. show one example of a homogenizer 100 according to the present invention. The homogenizer 100 is provided as a single apparatus having a separator 110, an agitator 130, and a hopper 150 integrated into a single unit with a common housing 101. The homogenizer 100 is configured to receive a composite feedstock composed of multiple raw materials of different types and to mix the composite feedstock into a substantially homogenous blend for outputting to a processing machine.

The separator 110 is configured to receive a material feed in the form of a fluid medium carrying a composite feedstock, and to substantially separate the composite feedstock from the fluid medium. Once separated from the carrying medium, the composite feedstock drops by gravity into the agitator 130, which is configured to mix the composite feedstock into a homogenous blend. Once sufficiently mixed, the agitator 130 releases the homogenous blend into the hopper 150, which is configured to collect a complete batch of homogenously blended feedstock for delivery to a processing machine or another storage container.

As seen in FIGS. 1-3, the separator 110 is provided with a receiving chamber 111 having a feed inlet 112, a vacuum outlet 113 and an unobstructed opening 114 at a bottom region of the receiving chamber 111 that leads directly into the agitator 130. The feed inlet 112 is provided for reception of a material feed into the receiving chamber 111, and is in communication with a feed supply (not shown) that contains a volume of composite feedstock. The vacuum outlet 113 is in communication with a vacuum unit (not shown) for generating a negative vacuum pressure within the receiving chamber 111. A separation mechanism, in the form of a filter 115, is provided within the receiving chamber 111, between the feed inlet 112 and the vacuum outlet 113. The filter 115 is provided with a mesh size that that is sufficient to permit passage of the fluid medium component while blocking passage of the composite feedstock component. An exact mesh size used in a homogenizer 100 will be determined in advance, based on the fluid medium and composite feedstock components to be handled thereby.

In operation, a negative vacuum pressure generated by the vacuum unit, via the vacuum outlet 113, creates a fluid flow that draws a material feed containing a composite feedstock from the feed supply into the receiving chamber 111, through the feed inlet 112. Once in the receiving chamber 111. the material feed is drawn toward the filter 115 by the vacuum force through the vacuum outlet 113. The filter 115 separates the composite feedstock from the fluid flow, with the fluid flow passing through the filter 115 and out the vacuum outlet 113 and the composite feedstock falling by gravity to the bottom region of the receiving chamber 111, through the unobstructed opening 114, and into the agitator 130.

As seen in FIGS. 1-3, a blowback unit 116 is provided at a top of the receiving chamber 111, at a side of the filter 115 opposite to the unobstructed opening 114. The blowback unit 116 operates to periodically generate a blowback fluid flow through the filter 115, in a direction opposite the vacuum fluid flow (i.e., the fluid flow generated by the vacuum force). The blowback fluid flow serves to forcefully eject any particles that have attached to the filter 115 so as to remove obstructions that could otherwise reduce the vacuum flow through the filter 115 and/or efficiency of the filter 115 is separating the fluid medium from the composite feedstock. Particles ejected by the blowback fluid flow drop by gravity to the bottom region of the receiving chamber 111, through the unobstructed opening 114, and into the agitator 130.

In the example shown in FIGS. 1-3, the agitator 130 is provided with mixing chamber 131 that is in flow communication with the receiving chamber 111 through the unobstructed opening 114, and a mixing mechanism 132 is provided within the mixing chamber 131. In the illustrated example, the mixing mechanism 132 is provided in the form of a stirrer having a central shaft 133 that extends through a center of the mixing chamber 131, with several protruding blades 134 provided along the shaft 133. A driving unit 135 is provided for driving the mixing mechanism 132—in the illustrated example, the driving unit 135 is provided as a motor that spins the central shaft 133 of the stirrer 132 to rotate the blades 134 within the mixing chamber 131.

The mixing chamber 131 comprises a lower wall 136 that is aligned at an angle α relative to ground. A gate 137 is provided for releasing feedstock from the mixing chamber 131 to the hopper 150. In the illustrated example, the gate 137 is provided at an end of the mixing chamber 131 that is positioned at a lower elevation of the tilted lower wall 136, such that feedstock is urged toward the gate 137 under the force of gravity. The gate 137 is moved between opened and closed positions by an actuator 138. In the illustrated example, the actuator 138 is shown as a pneumatic valve. In operation, once a composite feedstock has been sufficiently mixed to yield a homogeneous blend, the actuator 138 opens the gate 137, and the homogenously blended feedstock falls into the hopper 150 by sliding down the lower wall 136 and out the mixing chamber 131 under the force of gravity.

The lower wall 136 of the mixing chamber 131 is oriented at an angle α between about 15º to about 45°, preferably between about 25° to about 35°, and more preferably about 30°. In some examples, the lower wall 136 may be oriented near to or at 0° (i.e., parallel to ground), as this may result in a more efficient mixing of the feedstock. If orienting the lower wall 136 at angles approaching 0°, it may be desirable to include an ejection device (not shown) to facilitate removal of feedstock through the gate 137. Depending on the characteristics of the particular feedstock to be handled, an ejection device may prove especially beneficial when the lower wall 136 is oriented at an angle α that is between about 20° and about 0°.

Examples of ejection devices include, though are not limited to: a jet nozzle positioned at an end of the mixing chamber 131 opposite the gate 137 for delivering a stream of air to push feedstock toward the gate 137; a vacuum nozzle positioned at a wall outside the mixing chamber 131, facing the gate 137, for drawing feedstock out of the mixing chamber 131 when the gate 137 is open; a conveyer belt or vibration mechanism along the lower wall 136; and the like.

The hopper 150 is positioned below the agitator 130 and comprises a storage chamber 151 for receiving homogenously blended feedstock that is released from the mixing chamber 131 through the gate 137. An actuator controlled gate 152 is provided at the bottom of the hopper 151 for releasing feedstock from the storage chamber 151, and a batch sensor 153 is provided in storage chamber 151 for detecting the presence of feedstock and determining when a full batch of feedstock has been received therein. A suitable batch sensor 153 may include, though is not limited to, at least one of: a volumetric sensor; a height sensor; a weight sensor; and the like.

In operation, once it is determined that a full batch of homogenously blended feedstock has been received in the hopper 150, the agitator gate 137 is then closed and a new material feed is delivered to the separator 110 for the separation of a new batch of composite feedstock that is then passed to the agitator 130 for mixing. The homogenously blended feedstock in the hopper 150 is released through the hopper gate 152 for reception in a processing machine or a storage container.

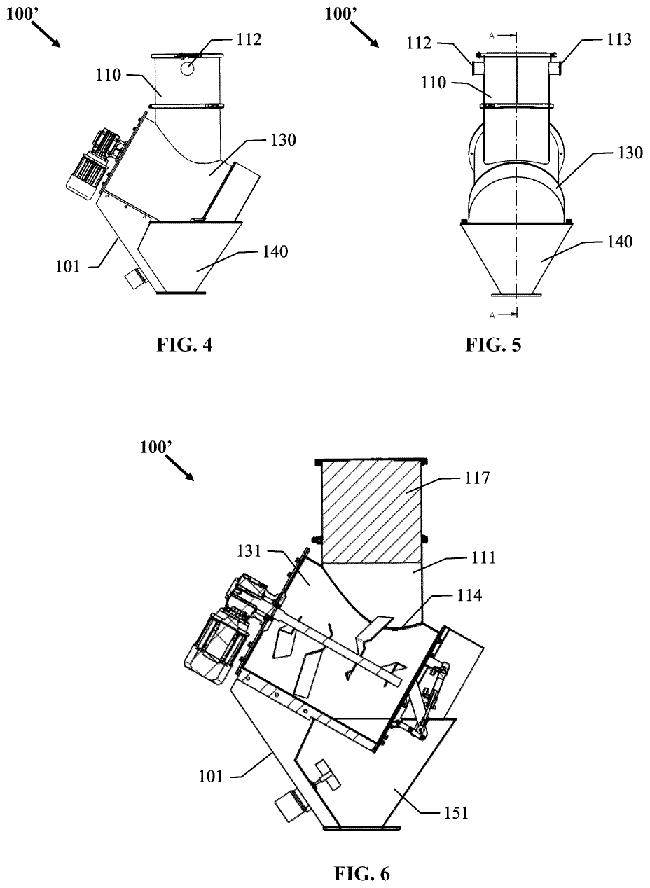

FIGS. 4-6 show another example of a homogenizer 100′ according to the present invention. Homogenizer 100′ is the same as homogenizer 100 in FIGS. 1-3, with the exception that homogenizer 100′ uses a separation mechanism in the form of a deflector baffle 117 for separating the composite feedstock from the carrying fluid (as opposed to the filter 115 in homogenizer 100). Corresponding references numbers are used in FIGS. 4-6 to identify common features as those in FIGS. 1-3, and a further discussion is not provided here of those common features.

The deflector baffle 117 is positioned within the reception chamber 111, between the feed inlet 112 and the vacuum outlet 113. The deflector baffle 117 is positioned, and sufficiently sized and dimensioned, to obstruct and deflect a flow of material feed through the reception chamber 111 such that there is induced a turbulent flow in the material feed that results in separation of the composite feedstock from the fluid medium. In the illustrated example, a material feed entering through the feed inlet 112 impacts the deflector baffle 117 and redirects downward toward a bottom region of the reception chamber 111. The deflector baffle 117 does not extend entirely into the bottom region of the reception chamber 11, and once the material feed passes beyond a bottom of the deflector baffle 117 the vacuum force generated by the vacuum unit draws the carrying fluid upward into the top region of the reception chamber 111, and out the vacuum outlet 113. The vacuum force is of insufficient strength to counteract the force of gravity on the feedstock, which is thus separated from the carrying fluid and drops to the bottom region of the reception chamber 111, through the unobstructed opening 114 and into the agitator 130.

In operation, a control unit (not shown) will periodically operate the vacuum device for a predetermined period of time to generate a negative pressure in the reception chamber, through the vacuum outlet 113. The period and frequency of operating the vacuum device will be determined in advance based on historical data as to the vacuum force needed to draw a targeted batch volume of composite feedstock into the reception chamber 111 through the feed inlet 112, which may vary depending on the fluid medium and feedstock employed.

If the homogenizer includes a separation mechanism in the form of a filter 114, then the control unit will periodically operate the blowback device 116 to eject particles that have attached to the filter 114. The period and frequency of operating the blowback device may be determined in advance based on historical data as to the fluid medium and feedstock employed, or may be effected based on feedback signals received at the control unit (e.g., pressure signals informing on a drop of pressure in the reception chamber 111 and/or the vacuum outlet 113).

The control unit may operate the mixing mechanism 132 in the agitator 130 to run either continuously or periodically. If operating periodically, the period and frequency of operation will be determined in advance based on the timing for a batch of composite feedstock to be separated from a carrying fluid medium and dropped into the agitator from the separator, which may vary depending on the fluid medium and feedstock employed. The period and frequency of operating the mixing mechanism 132 may also be determined in advance based on the time needed for mixing a composite feedstock to achieve a target homogeneity, which may vary depending on the feedstock employed.

The control unit periodically operates the actuator 138 to open and close the mixing chamber gate 137, to release a homogenously blended feedstock from the mixing chamber 131 into the storage chamber 151. The period and frequency of operating the actuator 138 to open and close the mixing chamber gate 137 may be determined in advance based on the duration of mixing needed within the mixing chamber 131 for achieving a target homogeneity of a composite feedstock, which may vary depending on the feedstock employed.

The control unit also receives signals from the batch sensor 153 in the storage chamber 151, informing on the presence of feedstock therein. The control unit is configured to use signals received from the batch sensor 153 to determine when a complete batch of feedstock has been received within the storage chamber 151 (corresponding with a complete emptying of the mixing chamber 131), and effects control of the vacuum device for drawing a subsequent batch of composite feedstock into the reception chamber 111 based on these determinations.

The control unit is configured to operate an actuator that opens and closes the storage chamber gate 152, to release a homogenously blended feedstock stored in the hopper 150 to a processing machine or a separate storage container.

Homogenizers according to the present invention provide beneficial improvements to manufacturing systems and processes, in that they simplify the overall constructions of the systems and reduce maintenance requirements for the same. For example, by providing the homogenizer as a single unit having an integrated agitator and separator, there is thus no need for a system to employ individual receiving and mixing units, effectively replacing two units with a single unit. A reduction from two individual units to a single unit also foregoes any need for flow controls for transferring a feedstock between two individual units. In addition to reducing the overall number of components in the system, a homogenizer with an integrated separator, as in the present invention, requires less operational space, both in terms of floor space and height. Furthermore, as a single unit, a homogenizer according to the present invention will reduce cleaning and maintenance demands, and reduce the likelihood of component failure, as compared to two individual units.

Though the present invention is described with reference to particular embodiments, it will be understood to those skilled in the art that the foregoing disclosure addresses exemplary embodiments only; that the scope of the invention is not limited to the disclosed embodiments; and that the scope of the invention may encompass additional embodiments embracing various changes and modifications relative to the examples disclosed herein without departing from the scope of the invention as defined in the appended claims and equivalents thereto.

Though the foregoing examples discuss the homogenizer as operating with a single control unit, it will be understood that one or more control units may be employed with individual control units effecting one or more separate controls from one another. In some examples, the homogenizer may omit the hopper, and homogenously blended feedstock released from the agitator, via the gate at the mixing chamber, may drop directly into a processing machine. The carrying fluid employed in the foregoing examples is preferably air, though is not limited thereto and may instead be any other gas or liquid.

The present invention is not limited to the exemplary embodiments illustrated herein, but is instead characterized by the appended claims, which in no way limit the scope of the disclosure.

What is claimed is:

1) An homogenizer for homogenously blending a feedstock, comprising:
a separator configured to receive a material feed in the form of a fluid medium carrying a composite feedstock, and to separate the composite feedstock from the fluid medium;
an agitator configured to receive the separated composite feedstock from the separator, and to mix the composite feedstock to yield the homogenously blended feedstock; and
a hopper configured to receive a homogenously blended feedstock from the agitator, and to hold the homogenously blended feedstock for release to either a processing machine or a storage container,
wherein the separator, agitator and hopper are integrated within a common housing.

2) The homogenizer according to claim 1, wherein
the separator comprises a reception chamber having a vacuum outlet and a feed inlet, the vacuum outlet being configured to communicate with a vacuum device for generation of a negative vacuum pressure within the reception chamber, and the feed inlet being configured to communicate with a feed supply for delivery of a material feed into the reception chamber under force of a negative pressure generated through the vacuum outlet.

3) The homogenizer according to claim 2, wherein
the separator comprises a separation mechanism within the reception chamber, the separation mechanism being positioned within a fluid flow path between the feed inlet and the vacuum outlet and configured to separate a material feed received through the feed inlet into substantially separate components of a fluid medium and a composite feedstock.

4) The homogenizer according to claim 3, wherein
the separator mechanism is a filter having a mesh size sufficient to permit passage of a fluid medium therethrough while blocking passage of a composite feedstock therethrough.

5) The homogenizer according to claim 4, wherein
the separator further comprises a blowback device configured to generate a blowback fluid flow through the filter for ejecting particles that have attached to the filter during separation of a composite feedstock from a fluid medium.

6) The homogenizer according to claim 3, wherein
the separator mechanism is a deflector baffle sized and dimensioned to obstruct and deflect a flow of material feed through the reception chamber, such that there is induced a turbulent flow in the material feed that separates the composite feedstock from the fluid medium.

7) The homogenizer according to claim 3, wherein
an unobstructed opening is provided in a bottom region of the reception chamber for passage of composite feedstock from the separator to the agitator, and
the separation mechanism is positioned in an upper region of the reception chamber such that composite feedstock separated from a fluid medium in a material feed falls by gravity to the bottom region of the separator, through the unobstructed opening, and into the agitator.

8) The homogenizer according to claim 1, wherein
the agitator comprises a mixing chamber having a mixing mechanism for mixing a composite feedstock to yield a homogenously blended feedstock, the mixing mechanism comprising at least one of: a stirrer; a screw; an auger; a shaker; and a rotating drum.

9) The homogenizer according to claim 8, wherein
a lower wall of the mixing chamber is oriented at an angle relative to ground with a release gate provided at a lower region of the mixing chamber such that feedstock within the mixing chamber is urged toward the release gate under force of gravity.

10) The homogenizer according to claim 9, wherein
the lower wall of the mixing chamber is oriented at an angle between about 15° to about 45°.

11) The homogenizer according to claim 8, wherein
the mixing chamber further comprises a release gate for releasing feedstock to the hopper, and an ejection device configured to urge feedstock through the release gate.

12) The homogenizer according to claim 11, wherein
the mixing chamber comprises a lower wall that is oriented at an angle relative to ground, the angle being between about 20° and about 0°.

13) The homogenizer according to claim 1, wherein
the hopper comprises a storage chamber and a batch sensor within the storage chamber, the batch sensor being configured to generate signals informing on the presence of a predetermined quantity of feedstock within the storage chamber.

14) The homogenizer according to claim 13, wherein
the batch sensor comprise at least one of: a volumetric sensor; a height sensor; and a weight sensor.

15) A method of homogenously blending a feedstock utilizing the homogenizer according to claim 1, comprising:
receiving a material feed comprising a fluid medium and a composite feedstock in the separator, through a feed inlet that communicates with a reception chamber within the separator;
separating the composite feedstock from the fluid medium, withdrawing the fluid medium from reception chamber, and passing the composite feedstock to the agitator;
mixing the composite feedstock in a mixing chamber of the agitator to yield a homogenously blended feedstock; and
releasing the homogenously blended feedstock from the agitator to the hopper.

16) The method according to claim 15, wherein
one or more control units are configured to:
periodically operate a vacuum device for a predetermined period of time to generate a negative pressure in the reception chamber for drawing a predetermined quantity of material feed into the reception chamber through the feed inlet;
operate a mixing mechanism in the agitator for a period of time that is predetermined to sufficiently mix a composite feedstock to yield a homogenously blended feedstock;
operate an actuator that controls a release gate in the mixing chamber for releasing a homogenously blended feedstock from the mixing chamber to the hopper; and
receive signals from a batch sensor in a storage chamber of the hopper to determine when a predetermined quantity of feedstock has been received within the storage chamber,
wherein the one or more control units is configured to periodically operate the vacuum device to deliver predetermined quantities of material feed into the reception chamber of the separator based on determinations made from the signals received from the batch sensor in the storage chamber of the hopper.
